(19) United States
(12) Patent Application Publication
(10) Pub. No.: US 2024/0112310 A1
(43) Pub. Date: Apr. 4, 2024

(54) DISTRIBUTED QUANTUM IMAGING METHOD, APPARATUS AND SYSTEM, AND COMPUTER-READABLE STORAGE MEDIUM

(71) Applicant: SHANDONG YINGXIN COMPUTER TECHNOLOGIES CO., LTD., Jinan, Shandgong (CN)

(72) Inventors: Xingchen CUI, Jinan, Shandong (CN); Hongzhi SHI, Jinan, Shandong (CN); Yuan GE, Jinan, Shandong (CN); Yingjie ZHANG, Jinan, Shandong (CN)

(21) Appl. No.: 18/270,236

(22) PCT Filed: Jan. 28, 2022
(86) PCT No.: PCT/CN2022/074607

§ 371 Date: Jun. 29, 2023

(30) Foreign Application Priority Data
Feb. 26, 2021 (CN) 202110217547.7

(51) Int. Cl. G06T 5/70; G06N 10/60; G06T 11/00

(52) U.S. Cl. CPC G06T 5/70; G06N 10/60; G06T 11/003

(57) ABSTRACT

Disclosed are a distributed quantum imaging method, apparatus and system, and a computer-readable storage medium. The distributed quantum imaging system comprises a plurality of laser devices that are placed at different spatial positions, a plurality of spatial light modulators, a detector and an imaging processor, wherein each laser device uniquely corresponds to one spatial light modulator. Each spatial light modulator is used for modulating a light field parameter generated by a corresponding laser device during each measurement process, and projecting a modulated light signal onto an object to be measured; the detector is used for collecting transmitted light obtained after an output light signal of each laser device passes through said object, converting the transmitted light into a corresponding measurement electrical signal and sending the measurement electrical signal to the imaging processor; and the imaging processor is used for performing reconstruction by using a compressed sensing algorithm, a sensing matrix that is constructed on the basis of light field information during a plurality of measurement processes, and the measurement electrical signal, so as to obtain information of said object. By means of the present application, the quantum imaging efficiency and the quantum imaging resolution can be effectively improved.

The present application claims the priority of the Chinese patent application filed on Feb. 26, 2021 before the CNIPA, China National Intellectual Property Administration with the application number of 202110217547.7 and the title of “DISTRIBUTED QUANTUM IMAGING METHOD, APPARATUS AND SYSTEM, AND COMPUTER-READABLE STORAGE MEDIUM”, which is incorporated herein in its entirety by reference.

### FIELD

The present application relates to the field of computer technologies, and more particularly, to a distributed quantum imaging method, apparatus and system, and a non-transitory computer-readable storage medium.

### BACKGROUND

Quantum imaging is a non-local imaging technology based on quantum fluctuations, also known as “Ghost Imaging”. Compared with traditional imaging technologies, the quantum imaging has the advantages of fast imaging speed and strong anti-interference ability, and is widely used in medical imaging, remote sensing imaging and other fields.

Traditional signal compression and reconstruction need to follow a Nyquist-Shannon sampling theorem, that is, a sampling rate needs to be at least twice a maximum frequency of a signal to guarantee distortion-free reconstruction, which undoubtedly puts increasing pressure on the signal during sampling, transmission, and storage. Related technologies usually use an optical correlation calculation imaging algorithm to perform an image recovery operation on quantum imaging, but they often require a large amount of sampling data, take a long time, and result in a low resolution of final imaging.

### SUMMARY

The present application provides a distributed quantum imaging method, apparatus and system, and a non-transitory computer-readable storage medium, which improve the quantum imaging efficiency and the quantum imaging resolution efficiently.

In order to solve the above technical problems, embodiments of the present application provide the following technical solutions.

In an aspect, an embodiment of the present application provides a distributed quantum imaging system. The distributed quantum imaging system includes a plurality of laser devices that is placed at different spatial positions, a plurality of spatial light modulators; a detector and an imaging processor, wherein each laser device uniquely corresponds to one spatial light modulator;
each spatial light modulator is configured to modulate a light field parameter generated by a corresponding laser device during in measurement process, and project a modulated light signal onto an object to be measured;
the detector is configured to collect transmitted light obtained in response to a light signal outputted from each laser device passing through the object to be measured, convert the transmitted light into a corresponding measurement electrical signal and send the measurement electrical signal to the imaging processor;
the imaging processor is configured to perform reconstruction by using a compressed sensing algorithm, a sensing matrix that is constructed on the basis of light field information in a plurality of measurement processes; and the measurement electrical signal; to obtain information on the object to be measured.

In an embodiment, the detector is a bucket detector.

Another embodiment of the present application provides a distributed quantum imaging method. The distributed quantum imaging method includes:
acquiring light field information generated by each laser device after parameter modulation in a corresponding spatial light modulator in each measurement process;
obtaining a measurement electrical signal according to transmitted light information which is collected by a detector in each measurement process and obtained in response to a light signal outputted from each laser device passing through an object to be measured;
generating a sensing matrix according to the light field information of each laser device; and
obtaining information on the object to be measured using a compressed sensing algorithm based on the sensing matrix and the measured electrical signal.

In an embodiment, the obtaining information on the object to be measured using a compressed sensing algorithm based on the sensing matrix and the measured electrical signal includes:
pre-constructing a quantum imaging relation formula: y=Φx;
in which: Φ∈R^{m*N}, y∈R^{m},

$$\\ Φ = [ \begin{matrix}{I}_{1} \\ {I}_{2} \\ ⋮ \\ {I}_{m}\end{matrix} ] ;$$

y is a measurement electrical signal matrix; Φ is the sensing matrix; x is the information on the object to be measured; R is a real number set; m is a total number of measurements; R^{m} is a real number vector of m dimensions; R^{m*N} is a real number matrix of m*N dimensions; Iₘ is an n*n matrix composed of the light field information of each laser device in the m^{th} measurement process; and n is a dimension of the matrix Iₘ, N=n²; and
obtaining the information x on the object to be measured by calculation using the quantum imaging relation formula, based on the sensing matrix and the measured electrical signal.

In an embodiment, each row of the sensing matrix is a mean value of the light field information generated by all laser devices in the current measurement process.

In an embodiment, each element in the measurement electrical signal matrix is a ratio of the total number of the measurement electrical signals in each measurement process to a total number of the laser devices.

In an embodiment, the obtaining information on the object to be measured using a compressed sensing algorithm based on the sensing matrix and the measured electrical signal includes:
presetting an iteration condition of an orthogonal matching pursuit algorithm; ending the iteration in response to the iteration condition indicating that a current residual is less than a preset minimum residual; continuing an iterative calculation in response to the current residual being not less than the preset minimum residual; and
obtaining the information on the object to be measured using the orthogonal matching pursuit algorithm, based on the sensing matrix and the measured electrical signal.

In an embodiment, the information on the object to be measured is calculated according to a reconstruction relation formula, the reconstruction relation formula being:

x′=(Φ^{T}Φ+αE)⁻¹Φ^{T}y;
in which: x′ is an approximate value of the information on the object to be measured; Φ is the sensing matrix; Φ^{T} is a transposed matrix of Φ; α is a regularization parameter; E is a unit matrix; and y is the measurement electrical signal.

An embodiment of the present application also provides a distributed quantum imaging apparatus. The distributed quantum imaging apparatus includes:
a light data acquiring module, configured to acquire light field information generated by, each laser device after parameter modulation in a corresponding spatial light modulator in each measurement process;
a measurement data sampling module, configured to obtain a measurement electrical signal according to transmitted light information which is collected by a detector in each measurement process and obtained in response to a light signal outputted from each laser device passing through an object to be measured; and
an information reconstruction module, configured to generate a sensing matrix according to the light field information of each laser device and obtain information on the object to be measured using a compressed sensing algorithm, based on the sensing matrix and the measurement electrical signal.

Eventually, an embodiment of the present application further provides a non-transitory computer-readable storage medium, configured to store a distributed quantum imaging program therein, the distributed quantum imaging program, when executed by a processor, being configured to implement the steps of the distributed quantum imaging method described in any of the above embodiments.

The technical solutions provided by the present application have the following advantages: a distributed laser light source is used in a data sampling stage to sample the information on the object to be measured, and prior to the subsequent image recovery algorithm, the measurement electrical signal and the sensing matrix are obtained according to the collected data, which initially reduces an error and improves a resolution of final imaging; a compressed sensing theory may be used to further complete the sampling and compression of a signal on the premise of sparsity or compressibility of the signal, thereby avoiding the waste of resources of traditional sampling and compression; and original signals may be restored accurately by using a small amount of sampling values to improve the efficiency of reconstructing images, thereby improving the efficiency of quantum imaging. Because the image recovery effect of the compressed sensing recovery algorithm is better than that of traditional quantum imaging, the resolution of the final image may also be improved, and the quality of the final imaging is further improved.

In addition, embodiments of the present application further provide a corresponding method, an implementation apparatus and a non-transitory computer-readable storage medium for the distributed quantum imaging system, which further make the system more feasible. The method, the apparatus and the non-transitory computer-readable storage medium have corresponding advantages.

It should be understood that the above general description and the following detailed description are only exemplary and illustrative, and not intended to limit the present application.

### BRIEF DESCRIPTION OF THE DRAWINGS

To describe the technical solutions of the embodiments of the present application and the prior more clearly, the following briefly introduces the accompanying drawings required for describing the embodiments and related technologies. Apparently, the accompanying drawings in the following description show only some embodiments of the present application, and a person of ordinary skill in the art may still derive other drawings from these accompanying drawings without creative efforts.

FIG. 1 is a schematic framework diagram of an exemplary application scenario provided by an embodiment of the present application;

FIG. 2 is a structural diagram of an implementation of a distributed quantum imaging system provided by an embodiment of the present application;

FIG. 3 is a schematic flowchart of a distributed quantum imaging method provided by an embodiment of the present application;

FIG. 4 is a structural diagram of an implementation of a distributed quantum imaging apparatus provided by an embodiment of the present application;

FIG. 5 is a structural diagram of an implementation of a distributed quantum imaging apparatus provided by an embodiment of the present application; and

FIG. 6 is a schematic diagram of a non-transitory computer-readable storage medium provided by an embodiment of the present application.

### DETAILED DESCRIPTION

In order to make those skilled in the art better understand the solutions of the present application, the present application will be further described below in conjunction with accompanying drawings and the embodiments. Of course, the described embodiments are merely some embodiments, rather than all embodiments, of the present application. Based on the embodiments of the present application, all other embodiments derived by a person of ordinary skill in the art without creative efforts shall fall within the protection scope of the present application.

The terms “first”, “second”, “third”, “fourth” and the like in the description and claims, as well as the above-mentioned drawings, in the present application are configured to distinguish similar objects, but not necessarily used to describe a specific order. In addition, the terms “including” and “having” and any variations thereof, are intended to override non-exclusive inclusions. For example, a process, method, system, product or device including a series of steps or units is not limited to the listed steps or units, but may include steps or units not listed.

A structure of a classical quantum imaging system is shown in FIG. 1, which may also be regarded as the traditional quantum imaging sampling principle. Firstly, a laser device 11 emits a laser, which then passes through a spatial light modulator 12 to generate a pseudothermal light source. Since the spatial light modulator 12 may set the distribution of light fields, there is no need to measure light field information. A bucket detector 14 has no spatial light resolution function, but functions to collect light passing through an object 13 to be measured. Then, the known light field information and the information collected by the bucket detector are subjected to a correlation calculation to recover the information of the object to be measured. The correlation calculation formula may be expressed as follows:

$$\\ T ( {x}_{0} , {y}_{0} ) = \frac{1}{M} {\sum }_{m = 1}^{M} ( {B}_{m} - 〈 {B}_{m} 〉 ) {I}_{m} ( {x}_{0} , {y}_{0} ) ; 〈 {B}_{m} 〉 = \frac{1}{M} {\sum }_{m = 1}^{M} {B}_{m} ;$$

in which: T(x₀, y₀) is information of the object after optical correlation calculation; x₀, y₀ are pixel point coordinate values; M is a total number of measurements; Bₘ is a total value of light intensity in the m^{th} measurement, which is also data collected by the bucket detector; Iₘ(x₀, y₀) is field intensity information of a light source in the m^{th} measurement; and <Bₘ> is a mean value of light intensity measured in the m^{th} measurement.

However, an optical correlation calculation imaging algorithm requires a large amount of sampling data, which takes a long time and results in low resolution of final imaging. Since quantum imaging may realize single-pixel imaging under a compressed sampling condition, in addition to optical correlation calculation, a recovery algorithm of compressed sensing may also be used to perform image recovery processing on the object to be measured. The compressed sensing theory takes the sparsity or compressibility of a signal as the premise, further completes the sampling and compression of the signal, avoids the waste of resources in traditional sampling and compression, and accurately restores an original signal by using a small amount of sampling values. Therefore, the compressed sensing theory has been widely used.

In view of this, according to the present application, distributed quantum imaging is performed on the basis of a compressed sensing recovery algorithm which substitutes for the traditional optical correlation calculation imaging algorithm, such that the amount of data required during sampling is reduced to ultimately achieve the purpose of reducing time consumption. In addition, since a picture recovery effect of the compressed sensing recovery algorithm is better than that of traditional quantum imaging, the resolution of the final imaging may also be improved.

After introducing the technical solutions of the embodiment of the present application, the following describes in detail various non-limitative implementations of the present application.

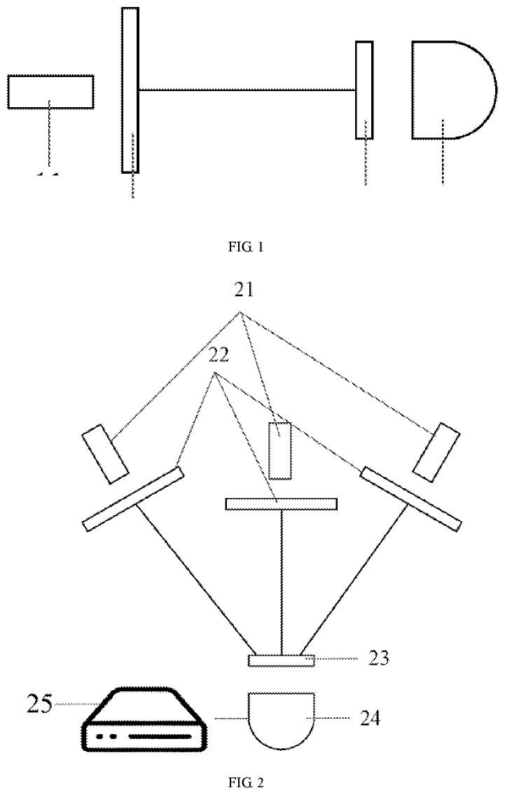

First of all, referring to FIG. 2, FIG. 2 is a structural framework diagram of a distributed quantum imaging system provided by an embodiment of the present application. This embodiment of the present application may include the following content:

a distributed quantum imaging system may include a plurality of laser devices 21 that is placed at different spatial positions, a plurality of spatial light modulators 22, a detector 24 and an imaging processor 25, wherein each laser device 21 uniquely corresponds to one spatial light modulator 22. That is, one spatial optical modulator 22 modulates an amplitude or frequency or other light field parameters of one laser device 21. This system uses a spatially distributed laser light source to irradiate an object. The total number of laser devices 21 and positions thereof placed in space may be selected according to an actual application scenario, both of which do not affect the implementation of the present application. For ease of description, only three laser devices are shown in FIG. 2. The spatial light modulator may modulate a parameter of the light field through liquid crystal molecules under active control. For example, the spatial light modulator may modulate the amplitude of the light field, modulate a phase based on a refractive index, modulate a polarization state by means of the rotation of a polarization surface, or realize the conversion of incoherent-coherent light, to write certain information into light waves to achieve the purpose of light wave modulation.

Each spatial light modulator 22 in the present application is configured to modulate a light field parameter generated by the corresponding laser device 21 in each measurement process, and project a modulated light signal to an object 23 to be measured. The object 23 to be measured is an object to be imaged. The object 23 to be measured may be, for example, a two-dimensional image. In order to reconstruct the information on the object 23 to be measured, sampling is performed for multiple times in the present application. Each sampling refers to one measurement process. The number of measurements and the way to modulate the light field parameter generated by the corresponding laser device 21 in each measurement process may be preset. The detector 24 is configured to collect transmitted light obtained in response to a light signal outputted from each laser device passing through the object 23 to be measured, convert the transmitted light into a corresponding measurement electrical signal and send the measurement electrical signal to the imaging processor 25. In order to collect transmitted light signals of the object to be measured as much as possible, the detector 24 may use a bucket detector. The imaging processor 25 is configured to perform reconstruction by using a compressed sensing algorithm, a sensing matrix that is constructed on the basis of light field information in a plurality of measurement processes, and the measurement electrical signal, to obtain the information on the object to be measured. The measurement electrical signal in the present embodiment includes measurement data employed by the detector 24 in each measurement process.

A workflow of the distributed quantum imaging system illustrated in the present embodiment is as follows:
during the first measurement, each laser device 21 emits a laser, which then passes through the corresponding spatial light modulator 22 to generate a pseudothermal light source, and transmits a light signal to the object 23 to be measured. The detector 24 collects data of light that passes through the object 23 to be measured, then converts the data into data in a format identifiable by the image processor 25 and sends the data to the imaging processor 25, as a measurement electrical signal of the current measurement process. The spatial light modulator 22 may send light field information generated by each laser device in the current measurement process to the imaging processor 25, and then end this measurement process. Then, a second measurement process is initiated. The spatial light modulator is used as needed to change the light field distribution of the laser light source. According to the above process, a measurement electrical signal in the second measurement process and the light field information generated by each laser light source are measured repeatedly according to the flow until the last measurement is completed. The imaging processor 25 is configured to perform reconstruction recovery based on a sensing matrix that is constructed on the basis of light field information in a plurality of measurement processes, and each measurement electrical signal.

In the technical solutions provided by the embodiments of the present application, a distributed laser light source is used in a data sampling stage to sample the information on the object to be measured, and prior to the subsequent image recovery algorithm, the measurement electrical signal and the sensing matrix are obtained according to the collected data, which initially reduces an error and improves a resolution of final imaging; a compressed sensing theory may be used to further complete the sampling and compression of a signal on the premise of sparsity or compressibility of the signal, thereby avoiding the waste of resources of traditional sampling and compression; and original signals may be restored accurately by using a small amount of sampling values to improve the efficiency of reconstructing images, thereby improving the efficiency of quantum imaging. Because the image recovery effect of the compressed sensing recovery algorithm is better than that of traditional quantum imaging, the resolution of final imaging may also be improved, and the quality of the final imaging is further improved.

Based on the above distributed quantum imaging system, the present application further provides a distributed quantum imaging method. Referring to FIG. 3, FIG. 3 is a schematic flowchart of a distributed quantum imaging method provided by an embodiment of the present application. The present embodiment of the present application embodiment may include the following content:

S301: acquiring light field information generated by each laser device after parameter modulation in a corresponding spatial light modulator in each measurement process;

S302: obtaining a measurement electrical signal according to transmitted light information which is collected by a detector in each measurement process and obtained in response to a light signal outputted from each laser device passing through an object to be measured;

S303: generating a sensing matrix according to the light field information of each laser device; and

S304: obtaining information on the object to be measured using a compressed sensing algorithm, based on the sensing matrix and the measured electrical signal.

The implementation of the respective steps of the distributed quantum imaging method described in the embodiment of the present application may refer to the relevant description described in the implementation process of respective functional modules in the distributed quantum imaging system, and will not be repeated herein.

In summary, the quantum imaging efficiency and the quantum imaging resolution can be effectively improved.

It should be noted that there is no strict order of execution among the respective steps in the present application, as long as they are in line with the logical order. These steps may be performed at the same time, or in a preset order. FIG. 3 is only a schematic way, does not mean at there is only such an execution order.

In the above embodiments, for the way to perform S304, the present embodiment further provides a recovery method for the information of the object to be measured, which may include the following content:
pre-constructing a quantum imaging relation formula as a mathematic mold of the distributed quantum imaging system, the quantum imaging relation formula being y=Φx; and
obtaining information x on the object to be measured by calculation using a quantum imaging relation formula, based on the sensing matrix and the measured electrical signal.
in which: Φ∈R^{m*N}, y∈R^{m},

$$\\ Φ = [ \begin{matrix}{I}_{1} \\ {I}_{2} \\ ⋮ \\ {I}_{m}\end{matrix} ] ;$$

y is a measurement electrical signal matrix; Φ is the sensing matrix; x is the information on the object to be measured; R is a real number set; m is a total number of measurements; R^{m} is a real number vector of m dimensions; R^{m*N} is a real number matrix of m*N dimensions; Iₘ is an n*n matrix composed of the light field information of each laser device in the m^{th} measurement process; and n is a dimension of the matrix Iₘ, N=n². Assuming that light field information Iᵢ generated by the i^{th} laser device is represented as a matrix of n*n, i=1, 2, . . . , I, and I is the total number of laser devices, then in one sampling process, may be regarded as a row vector of I*n² to perform a matrix operation with the object. Therefore, the m^{th} row in the sensing matrix Φ is the row vector representation of the light field information in the m^{th} measurement process.

In one implementation of the present embodiment, each row of the sensing matrix Φ is a mean value of the light field information generated by all laser devices in the current measurement process. That is, I pieces of light field information are also calculated for a mean value as a row of the sensing matrix Φ. In another implementation of the present embodiment, each element in the measurement electrical signal matrix is a ratio of the total number of the measurement electrical signals in each measurement process to the total number of the laser devices. That is, a measured value received by the detector and I are averaged to obtain a mean value as an element of a measured value y. Averaging the measurements from a plurality of perspectives may reduce errors and improves the imaging accuracy.

As an implementation, the present embodiment may use an improved orthogonal matching pursuit (OMP) algorithm to calculate the information on the object to be measured, with efficiency and accuracy being superior to those of the traditional OMP reconstruction algorithm.

The recovery process of the traditional OMP reconstruction algorithm is as follows: after acquiring a sampling vector y of an original signal, it is first necessary to estimate its sparsity K according to prior conditions or empirical values, and then use K as an iterative termination condition and iterate K times to restore the information of the original image. This traditional method has three drawbacks: firstly, the estimated sparsity K will introduce an error; secondly, if the value of K is large, the iteration process consumes too more time, which greatly affects the efficiency of the compressed sensing process; and finally, in the reconstruction process, the traditional OMP uses a least squares method for data operation, which leads to a relatively slow calculation process due to the drawbacks of the least squares method itself, resulting in low efficiency of the entire compressed sensing process.

In response to the above problems, the present embodiment improves the OMP reconstruction algorithm to enhance the accuracy and efficiency of the recovery algorithm, thereby improving the accuracy and efficiency of the entire compressed sensing process. The present embodiment may include the following content:
presetting an iteration condition of an orthogonal matching pursuit algorithm; ending the iteration in response to the iteration condition indicating that a current residual is less than a preset minimum residual; continuing an iterative calculation in response to the current residual being not less than the preset minimum residual; and
obtaining the information on the object to be measured by calculation using the orthogonal matching pursuit algorithm, based on the sensing matrix and the measured electrical signal.

In the present embodiment, it is known that y=Φx, where y is a sampling vector, Φ is a sensing matrix, and x is an original signal. In addition, Φ∈R^{m*N}, y∈R^{m}. Therefore, it can be seen from linear algebra that a solution of x is not unique. For a case where the solution is not unique, it is necessary to add some restrictions to narrow the scope of the solution, to obtain a unique solution.

The least squares method may be used to solve a system of linear equations, and thus applied in the OMP algorithm. That is, it is solved: x′=argmin∥y−Φₓ∥₂=Φ⁺·y, where Φ⁺=(Φ^{T}·Φ)⁻¹·Φ^{T}. Through Tikhonov regularization, the traditional least squares method is improved so that x′=(Φ^{T} Φ+αE)⁻¹Φ^{T}y. In combination with the distributed quantum imaging system applied in the present application, the information on the object to be measured may be calculated according to a reconstruction relation formula, which is x′=(Φ^{T} Φ+αE)⁻¹Φ^{T}y;
in which: x′ is an approximate value of the information on the object to be measured; Φ is the sensing matrix; Φ^{T} is a transposed matrix of Φ; α is a regularization parameter; E is a unit matrix; and y is the measurement electrical signal.

By introducing the above orthogonal improvements, the original least squares algorithm may be replaced, thereby improving the calculation efficiency. Then, by changing the iteration condition, the iteration may be ended when K times of iteration performed by the traditional OMP algorithm may be changed to a case where a residual is less than a certain threshold. The present embodiment excludes the influence of sparsity K on the number of iterations and accuracy by changing the iteration condition, to solve the problems of errors introduced by estimating K parameters and the long iteration time caused by excessive K parameters. This recovery algorithm may improve the speed of the reconstruction algorithm while ensuring the signal recovery accuracy, thereby improving the efficiency of the entire compressed sensing process. Also, because there is no need to estimate the sparsity K of the original signal, the accuracy of compressed sensing is also improved, which in turn may improve the efficiency and accuracy of the entire distributed quantum imaging system.

In the present embodiment, the implementation process of reconstructing the original signal using the improved OMP reconstruction algorithm is as follows:
input: sensing matrix Φ, sampling vector y, y=Φx, minimum residual a, and regularization parameter α>0;
initialization: residual r having an initial value r₀=y, index set Λ=Ø, t=1, t being the number of iterations;
output: k sparsity approximation value of x being x′;
iteration termination flag: r≤ε;
Step 1: finding the residual r and a footnote λ corresponding to a maximum value of a column Φⱼ of the sensing matrix Φ, λt=argmax∥<zₜ₋₁, Φⱼ>;
Step 2: updating an index: Λₜ=Λₜ₋₁∪{λₜ}, and recording a reconstructed atomic set Φₜ=[Φₜ₋₁, Φ_{λt}] of the found sensing matrix;
Step 3: acquiring the approximate value x′ of x according to x′=(Φ^{T}Φ+αE)⁻¹ Φ^{T}y;
Step 4: updating the residual value rₜ=y−Φₜx′ₜ, t=t+1;
Step 5: determining whether rₜ is less than or equal to a, stopping the iteration in response to rₜ being less than or equal to ε, and continuing to perform Step 1 in response to Rₜ being greater than ε; and
Step 6: outputting signal data calculated by reconstruction according to the reconstruction algorithm, that is, obtaining the information on the object to be measured.

It can be seen from the above content that the embodiment of the present application reduces a sampling error by improving the quantum imaging sampling system. At the level of the image recovery algorithm, the improved algorithm using the reconstruction algorithm of compressed sensing not only replaces the least squares algorithm that takes the most time in the classical OMP algorithm, but also eliminates the problem of more iterations caused by large sparsity K, thereby improving the efficiency of the reconstruction algorithm, and thus improving the efficiency of the entire compressed sensing process. Also, because the sparsity value K is not used in the present embodiment, an error introduced in the case of estimating K may be excluded, thereby improving the accuracy of the compressed sensing process. Through the improvement of sampling and recovery algorithms, the overall quantum imaging efficiency and quantum imaging quality are improved compared with traditional quantum imaging.

An embodiment of the present application further provides a corresponding apparatus for the distributed quantum imaging method, further making the method more feasible. The apparatus may be described separately from the perspective of a functional module and the perspective of hardware. The distributed quantum imaging apparatus provided by the embodiment of the present application is described below. In addition, the distributed quantum imaging apparatus described below and the distributed quantum imaging method described above may be referred to one another.

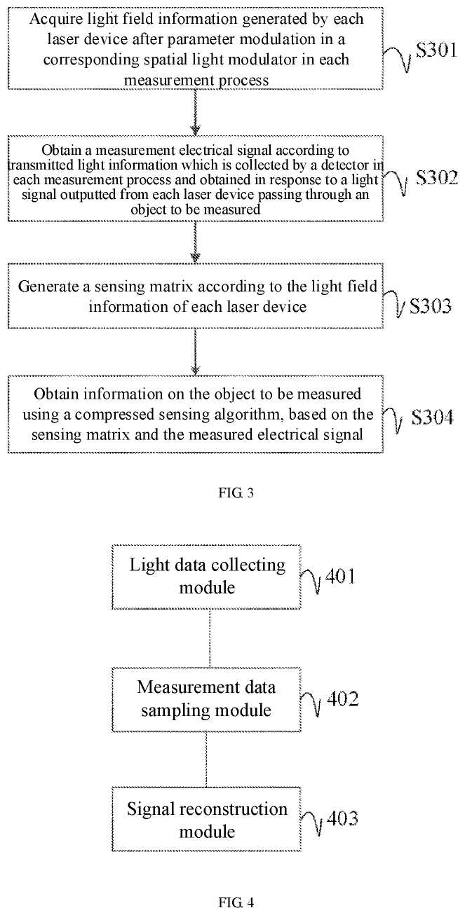

Based on the perspective of a functional module, referring to FIG. 4, FIG. 4 is a structural diagram of a distributed quantum imaging apparatus provided by an embodiment of the present application in an implementation. The apparatus may include:
a light data acquiring module 401, configured to acquire light field information generated by each laser device after parameter modulation in a corresponding spatial light modulator in each measurement process;
a measurement data sampling module 402, configured to obtain a measurement electrical signal according to transmitted light information which is collected by a detector in each measurement process and obtained in response to a light signal outputted from each laser device passing through an object to be measured; and
an information reconstruction module 403, configured to generate a sensing matrix according to the light field information of each laser device, and obtain information on the object to be measured using a compressed sensing algorithm, based on the sensing matrix and the measurement electrical signal.

In some implementations of the present embodiment, the signal reconstruction module 403 may be further configured to:
pre-construct a quantum imaging relation formula: y=Φx;
in which: Φ∈R^{m*N}, y∈R^{m},

$$\\ Φ = [ \begin{matrix}{I}_{1} \\ {I}_{2} \\ ⋮ \\ {I}_{m}\end{matrix} ] ;$$

y is a measurement electrical signal matrix; Φ is the sensing matrix; x is the information on the object to be measured; R is a real number set; R^{m} is a real number vector of m dimensions; R^{m*N} is a real number matrix of m*N dimensions; m is a total number of measurements; Iₘ is an n*n matrix composed of the light field information of each laser device in the m^{th} measurement process; and n is a dimension of the matrix Iₘ, N=n²; and
obtain information x on the object to be measured by calculation using a quantum imaging relation formula, based on the sensing matrix and the measured electrical signal.

According to some embodiments, in other implementations of the present embodiment, the signal reconstruction module 403 may be further configured to:
preset an iteration condition of an orthogonal matching pursuit algorithm; end the iteration in response to the iteration condition indicating that a current residual is less than a preset minimum residual; continue an iterative calculation in response to the current residual being not less than the preset minimum residual; and
obtain the information on the object to be measured by calculation using the orthogonal matching pursuit algorithm, based on the sensing matrix and the measured electrical signal.

As some other implementations of the present embodiment, the signal reconstruction module 403 may be further configured to:
obtain the information on the object to be measured by calculation according to a reconstruction relation formula; the reconstruction relationship being:

x′=(Φ^{T}Φ+αE)⁻¹Φ^{T}y;
in which: x′ is an approximate value of the information on the object to be measured; Φ is the sensing matrix; Φ^{T} is a transposed matrix of Φ; α is a regularization parameter; E is a unit matrix; and y is the measurement electrical signal.

The functions of respective functional modules of the distributed quantum imaging apparatus described in the embodiment of the present application may be implemented according to the method in the method embodiment, and the implementation process may refer to the relevant descriptions of the method embodiment, which will not be repeated herein.

In summary, the embodiments of the present application may effectively improve the quantum imaging efficiency and the quantum imaging resolution.

The distributed quantum imaging apparatus mentioned above is described from the perspective of a functional module. Further, the present application further provides a distributed quantum imaging apparatus, which is described from a hardware perspective. FIG. 5 is a structural diagram of another distributed quantum imaging apparatus provided by an embodiment of the present application. As shown in FIG. 5, the apparatus includes a memory 50 configured to store a computer program therein; and
a processor 51, configured to execute the computer program to implement the steps of the distributed quantum imaging method according to any one of the above embodiments.

The processor 51 may include one or more processing cores, such as a 4-core processor and an 8-core processor. The processor 51 may be implemented by at least one hardware of a digital signal processing (DSP), a field-programmable gate array (FPGA), and a programmable logic array (PLA). The processor 51 may also include a main processor and a coprocessor. The main processor is a processor configured to process the data in an awake state, and is also called a central processing unit (CPU). The coprocessor is a low-power-consumption processor configured to process the data in a standby state. In some embodiments, the processor 51 may be integrated with a graphics processing unit (GPU), which is configured to render and draw the content that needs to be displayed by a display screen. In some embodiments, the processor 51 may also include an artificial intelligence (AI) processor configured to process computational operations related to machine learning.

The memory 50 may include one or more non-transitory computer-readable storage mediums, which can be non-transitory. The memory 50 may also include a high-speed random access memory, as well as a non-volatile memory, such as one or more disk storage devices and flash storage devices. In the present embodiment, the memory 50 is at least configured to store the following computer program 501 therein, wherein the computer program is loaded and executed by the processor 51 to implement related steps of the distributed quantum imaging method disclosed in any of the foregoing embodiments. In addition, resources stored in the memory 50 may also include an operating system 502 and data 503, and a storage method may be temporary storage or permanent storage. The operating system 502 may include Windows, Unix, Linux, etc. The data 503 may include, but is not limited to, data corresponding to distributed quantum imaging results.

In some embodiments, the distributed quantum imaging apparatus may also include a display 52, an input/output interface 53, a communication interface 54, a power source 55, and a communication bus 56.

It may be understood by those skilled in the art that the structure shown in FIG. 5 does not constitute any limitation to the distributed quantum imaging apparatus, and may include more or less components than those illustrated, for example, may include a sensor 57.

The functions of respective functional modules of the distributed quantum imaging apparatus described in the embodiments of the present application may be implemented according to the method in the method embodiment, and the implementation process may refer to the relevant descriptions of the method embodiment, which will not be repeated herein.

In summary, the embodiments of the present application may effectively improve the quantum imaging efficiency and the quantum imaging resolution.

It may be understood that the distributed quantum imaging method in the above embodiments, if implemented in the form of a software functional unit and sold or used as a separate product, may be stored in a non-transitory computer-readable storage medium. Based on this understanding, the technical solutions of the present application in essence (or parts contributed to the prior art) or all or part of the technical solutions may be embodied in the form of a software product. This computer software product is stored in a storage medium to perform all or part of the steps of the methods in respective embodiments of the present application. The aforementioned storage media include: U disk, portable hard disk, read-only memory (ROM), random access memory (RAM), electrically erasable programmable ROM, a register, a hard disk, a removable disk, CD-ROM, a magnetic disk or an optical disc or other media that can store program codes therein.

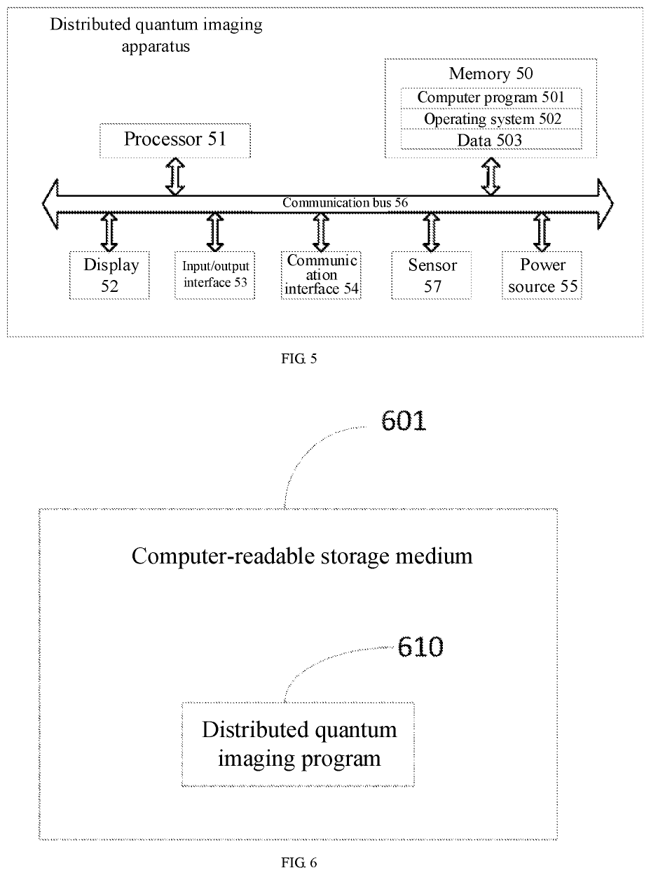

In view of this, FIG. 6 shows a schematic diagram of a non-transitory computer-readable storage medium provided by an embodiment of the present application. As shown in FIG. 6, an embodiment of the present application further provides a non-transitory computer-readable storage medium 601, configured to store a distributed quantum imaging program 610 therein, the distributed quantum imaging program 610 being executed by a processor to perform the steps of the distributed quantum imaging method as described in any of the above embodiments.

The functions of respective functional modules of the non-transitory computer-readable storage medium described in the embodiments of the present application may be implemented according to the method in the method embodiment, and the implementation process may refer to the relevant descriptions of the method embodiment, which will not be repeated herein.

In summary, the embodiments of the present application may effectively improve the quantum imaging efficiency and the quantum imaging resolution.

The respective embodiments of the present description are described in a progressive manner, the focus of each embodiment illustrates the differences from other embodiments, and the same or similar parts among the embodiments may refer to one another. Since the apparatus disclosed in the embodiments corresponds to the method disclosed in the embodiments, the description is relatively simple, and the relevant parts may refer to the description of the method part.

Those skilled in the art may be aware that the units and algorithm steps described in combination with each example described in embodiments disclosed herein may be implemented by electronic hardware, computer software, or a combination thereof. In order to clearly illustrate the interchangeability of hardware and software, the composition and steps of each example have been generally described in accordance with the functions in the above description. Whether such functions are implemented by means of hardware or software depends upon the particular application and design constraints imposed on the technical solutions. Those skilled in the art may use different methods for each particular application to achieve the described functions, but such implementation should not be considered beyond the scope of the present application.

The distributed quantum imaging method, apparatus and system, and the non-transitory computer-readable storage medium provided by the present application are described in detail above. Specific examples are applied herein to explain the principles and embodiments of the present application, but the above embodiments are only used to help understand the method and core ideas of the present application. It should be pointed out that those of ordinary skill in the art may also make several improvements and modifications without departing from the principles of the present application, which should be considered as the protection scope of the present application.

1. A distributed quantum imaging system, comprising a plurality of laser devices that is placed at different spatial positions, a plurality of spatial light modulators, a detector and an imaging processor, wherein each laser device uniquely corresponds to one spatial light modulator;
each spatial light modulator is configured to modulate a light field parameter generated by a corresponding laser device in each measurement process, and project a modulated light signal onto an object to be measured;
the detector is configured to collect transmitted light obtained in response to a light signal outputted from each laser device passing through the object to be measured, convert the transmitted light into a corresponding measurement electrical signal and send the measurement electrical signal to the imaging processor; and
the imaging processor is configured to perform reconstruction by using a compressed sensing algorithm, a sensing matrix that is constructed on the basis of light field information in a plurality of measurement processes, and the measurement electrical signal.

2. The distributed quantum imaging system according to claim 1, wherein the detector is a bucket detector.

3. A distributed quantum imaging method, comprising:
acquiring light field information generated by each laser device after parameter modulation in a corresponding spatial light modulator in each measurement process;
obtaining a measurement electrical signal according to transmitted light information which is collected by a detector in each measurement process and obtained in response to a light signal outputted from each laser device passing through an object to be measured;
generating a sensing matrix according to the light d information of each laser device; and
obtaining information on the object to be measured using a compressed sensing algorithm based on the sensing matrix and the measured electrical signal.

4. The distributed quantum aging method according to claim 1, wherein the obtaining information on the object to be measured using a compressed sensing algorithm, based on the sensing matrix and the measured electrical signal comprises:
pre-constructing a quantum imaging relation formula: y=Φx;
in which: Φ∈R^{m*N}, y∈R^{m},
$$\\ Φ = [ \begin{matrix}{I}_{1} \\ {I}_{2} \\ ⋮ \\ {I}_{m}\end{matrix} ] ;$$
is a measurement electrical signal matrix; Φ is the sensing matrix; x is the information on the object to be measured; R is a real number set; m is a total number of measurements; R^{m} is a real number vector of m dimensions; R^{m*N} is a real number matrix of m*N dimensions; Iₘ is an n*n matrix composed of the light field information of each laser device in the m^{th} measurement process; and n is a dimension of the matrix Iₘ, N=n²; and
obtaining the information x on the object to be measured by calculation using the quantum imaging relation formula, based on the sensing matrix and the measured electrical signal.

5. The distributed quantum imaging method according to claim 4, wherein each row of the sensing matrix is a mean value of the light field information generated by all laser devices in the current measurement process.

6. The distributed quantum imaging method according to claim 5, wherein each element in the measurement electrical signal matrix is a ratio of the total number of the measurement electrical signals in each measurement process to a total number of the laser devices.

7. The distributed quantum imaging method according to claim 3, wherein the obtaining information on the object to be measured using a compressed sensing algorithm, based on the sensing matrix and the measured electrical signal comprises:
presetting an iteration condition of an orthogonal matching pursuit algorithm; ending the iteration in response to the iteration condition indicating that a current residual is less than a preset minimum residual; continuing an iterative calculation in response to the current residual being not less than the preset minimum residual; and
obtaining the information on the object to be measured using the orthogonal matching pursuit algorithm, based on the sensing matrix and the measured electrical signal.

8. The distributed quantum imaging method according to claim 7, wherein the information on the object to be measured is calculated according to a reconstruction relation formula, the reconstruction relation formula being:
x′=(Φ^{T}Φ+αE)⁻¹Φ^{T}y;
in which: x′ is an approximate value of the information on the object to be measured; Φ is the sensing matrix; Φ^{T} is a transposed matrix of Φ; α is a regularization parameter; E is a unit matrix; and y is the measurement electrical signal.

9. A distributed quantum imaging apparatus, comprising:
a processor, and
a memory storing computer-readable codes, wherein when the computer-readable codes are run on the processor, the distributed quantum imaging apparatus is made to implement operations comprising:
acquiring light field information generated by each laser device after parameter modulation in a corresponding spatial light modulator in each measurement process;
obtaining a measurement electrical signal according to transmitted light information which is collected by a detector in each measurement process and obtained in response to a light signal outputted from each laser device passing through an object to be measured; and
generating a sensing matrix according to the light field information of each laser device and obtaining information on the object to be measured using a compressed sensing algorithm, based on the sensing matrix and the measurement electrical signal.

10. A non-transitory computer-readable storage medium, configured to store a distributed quantum imaging program therein, the distributed quantum imaging program, when executed by a processor, being configured to implement the steps of the distributed quantum imaging method according to claim 3.

11. The distributed quantum imaging system according to claim 3, wherein the measurement electrical signal comprises measurement data employed by the detector in each measurement process.

12. The distributed quantum imaging system according to claim 4, wherein the obtaining information on the object to be measured using a compressed sensing algorithm, based on the sensing matrix and the measured electrical signal comprises:
presetting an iteration condition of an orthogonal matching pursuit algorithm; ending the iteration in response to the iteration condition indicating that a current residual is less than a preset minimum residual; continuing an iterative calculation in response to the current residual being not less than the preset minimum residual; and
obtaining the information on the object to be measured using the orthogonal matching pursuit algorithm, based on the sensing matrix and the measured electrical signal.

13. The distributed quantum imaging system according to claim 5, wherein the obtaining information on the object to be measured using a compressed sensing algorithm; based on the sensing matrix and the measured electrical signal comprises:
presetting an iteration condition of an orthogonal matching pursuit algorithm; ending the iteration in response to the iteration condition indicating that a current residual is less than a preset minimum residual; continuing an iterative calculation in response to the current residual being not less than the preset minimum residual; and
obtaining the information on the object to be measured using the orthogonal matching pursuit algorithm, based on the sensing matrix and the measured electrical signal.

14. The distributed quantum imaging system according to claim 6, wherein the obtaining information on the object to be measured using a compressed sensing algorithm, based on the sensing matrix and the measured electrical signal comprises:
presetting an iteration condition of an orthogonal matching pursuit algorithm; ending the iteration in response to the iteration condition indicating that a current residual is less than a preset minimum residual; continuing an iterative calculation in response to the current residual being not less than the preset minimum residual; and
obtaining the information on the object to be measured using the orthogonal matching pursuit algorithm, based on the sensing matrix and the measured electrical signal.

15. The distributed quantum imaging apparatus according to claim 9, wherein the operation of obtaining information on the object to be measured using a compressed sensing algorithm, based on the sensing matrix and the measured electrical signal comprises:
pre-constructing a quantum imaging relation formula: y=Φx;
in which: Φ∈R^{m*N}, y∈R^{m},
$$\\ Φ = [ \begin{matrix}{I}_{1} \\ {I}_{2} \\ ⋮ \\ {I}_{m}\end{matrix} ] ;$$
y is a measurement electrical signal matrix; Φ is the sensing matrix; x is the information on the object to be measured; R is a real number set; m is a total number of measurements; R^{m} is a real number vector of m dimensions; R^{m*N} is a real number matrix of m*N dimensions; Iₘ is an n*n matrix composed of the light field information of each laser device in the m^{th} measurement process; and n is a dimension of the matrix Iₘ, N=n²; and
obtaining the information x on the object to be measured by calculation using the quantum imaging relation formula, based on the sensing matrix and the measured electrical signal.

16. The distributed quantum imaging apparatus according to claim 15, wherein each row of the sensing matrix is a mean value of the light field information generated by all laser devices in the current measurement process.

17. The distributed quantum imaging apparatus according to claim 16, wherein each element in the measurement electrical signal matrix is a ratio of the total number of the measurement electrical signals in each measurement process to a total number of the laser devices.

18. The distributed quantum imaging apparatus according to claim 9, wherein the operation of obtaining information on the object to be measured using a compressed sensing algorithm, based on the sensing matrix and the measured electrical signal comprises:
presetting an iteration condition of an orthogonal matching pursuit algorithm; ending the iteration in response to the iteration condition indicating that a current residual is less than a preset minimum residual; continuing an iterative calculation in response to the current residual being not less than the preset minimum residual; and
obtaining the information on the object to be measured using the orthogonal matching pursuit algorithm, based on the sensing matrix and the measured electrical signal.

19. The non-transitory computer-readable storage medium according to claim 10, wherein the operation of obtaining information on the object to be measured using a compressed sensing algorithm, based on the sensing matrix and the measured electrical signal comprises:
pre-constructing a quantum imaging relation formula: y=Φx;
in which: Φ∈R^{m*N}, y∈R^{m},
$$\\ Φ = [ \begin{matrix}{I}_{1} \\ {I}_{2} \\ ⋮ \\ {I}_{m}\end{matrix} ] ;$$
y is a measurement electrical signal matrix; Φ is the sensing matrix; x is the information on the object to be measured; R is a real number set; m is a total number of measurements; R^{m} is a real number vector of m dimensions; R^{m*N} is a real number matrix of m*N dimensions; Iₘ is an n*n matrix composed of the light field information of each laser device in the m^{th} measurement process; and n is a dimension of the matrix Iₘ, N=n²; and
obtaining the information x on the object to be measured by calculation using the quantum imaging relation formula, based on the sensing matrix and the measured electrical signal.

20. The non-transitory computer-readable storage medium according to claim 19, wherein each row of the sensing matrix is a mean value of the light field information generated by all laser devices in the current measurement process.
